(19) United States
(12) Patent Application Publication
(10) Pub. No.: US 2022/0307671 A1
(43) Pub. Date: Sep. 29, 2022

(54) Motor Vehicle with a Surroundings Lighting Device

(71) Applicant: Bayerische Motoren Werke Aktiengesellschaft, Muenchen (DE)

(72) Inventors: Christopher BREMER, Augsburg (DE); Rene UEBLER, Muenchen (DE)

(21) Appl. No.: 17/635,428

(22) PCT Filed: Sep. 21, 2020
(86) PCT No.: PCT/EP2020/076300

§ 371 Date: Feb. 15, 2022

(30) Foreign Application Priority Data
Oct. 11, 2019 (DE) 10 2019 127 406.0

(51) Int. Cl. F21S 43/50; F21S 43/14; B60Q 1/18; B60Q 1/26; B60Q 1/50

(52) U.S. Cl. CPC F21S 43/50; F21S 43/14; B60Q 1/18; B60Q 1/2696; B60Q 1/503; B60Q 2400/50; B60Q 2400/40

(57) ABSTRACT

A motor vehicle includes a surroundings lighting device with a plurality of projection modules for generating a light distribution on the ground in the surroundings of the motor vehicle. The plurality of projection modules includes a first projection module and a second projection module which are designed and arranged such that when operated the first projection module generates a first light distribution on the ground in the surroundings of the motor vehicle and the second projection module generates a second light distribution which overlaps with the first light distribution on the ground in the surroundings of the motor vehicle. The second light distribution covers a smaller surface area on the ground than the first light distribution and has a higher average illuminance on the ground than the first light distribution.

### BACKGROUND AND SUMMARY OF THE INVENTION

The invention relates to a motor vehicle with a surroundings lighting device.

Installing a surroundings lighting device made up of one or more projection modules, which each generate a predefined light distribution on the ground in the surroundings of the motor vehicle, is known from the prior art. For example, document DE 10 2013 211 877 A1 discloses a motor vehicle in which separate light distributions are generated laterally adjacent to the motor vehicle via projection modules in the door sills on both sides of the motor vehicle.

The object of the invention is to provide a motor vehicle having a surroundings lighting device, using which a novel light distribution can be generated in the surroundings of the motor vehicle.

This object is achieved by the claimed invention.

The motor vehicle according to an embodiment of the invention comprises a surroundings lighting device having a plurality of projection modules for generating light distributions on the ground in the surroundings of the motor vehicle. The motor vehicle is preferably a passenger car, but may if appropriate also be a truck.

The plurality of projection modules comprises two separate projection modules in the form of a first projection module and a second projection module, which are designed and arranged in such a way that when they are in operation, the first projection module generates a first light distribution on the ground in the surroundings of the motor vehicle and the second projection module generates a second light distribution, overlapping with the first light distribution, on the ground in the surroundings of the motor vehicle. The term “overlapping” is to be understood here and hereinafter as meaning that at least one subregion of the one light distribution coincides with at least one subregion of the other light distribution.

According to an embodiment of the invention, the second light distribution created using the second projection module covers a smaller area on the ground than the first light distribution does. Furthermore, it has a higher average illuminance on the ground than the first light distribution does. The concept of the average illuminance is to be understood as meaning that the mean of the illuminance is taken over the area covered by the light distribution on the ground.

According to an embodiment of the invention, an overall light distribution is provided, which is composed of a background in the form of a first light distribution having lower illuminance and a foreground in the form of a second light distribution having higher illuminance, but a smaller size. Pleasant projections can thus be generated on the ground in the surroundings of the motor vehicle by way of the use of multiple separate projection modules.

In one particularly preferred embodiment, the average illuminance of the second light distribution on the ground is 200% or more of the average illuminance of the first light distribution on the ground. Alternatively or additionally, the area of the second light distribution on the ground is 50% or less of the area of the first light distribution on the ground. In this way, the second light distribution, i.e. the light distribution of the foreground, can stand out clearly from the first light distribution, i.e. the light distribution of the background.

In a further preferred embodiment, the second light distribution contains symbols. The symbols preferably contain one or more graphic and/or text elements. In particular, the symbols may be one or more logos.

In a further preferred configuration, the second light distribution is located completely inside the first light distribution. This is not absolutely required, however; rather, the second light distribution may also be located partially outside the first light distribution. However, it is essential that the two light distributions have an overlapping region, so that they are perceived by a human observer as parts of an overall light distribution.

The first light distribution may be designed differently depending on the embodiment. In one variant, the first light distribution is a homogeneously illuminated area, but the first light distribution may, if appropriate, also be a predefined pattern, for example a strip pattern.

In a further preferred configuration, the first projection module and/or the second projection module are each configured to generate white light or colored light. In this respect, the first projection module preferably creates white light and the second projection module preferably creates colored light. It is also possible that the first projection module creates colored light and the second projection module creates white light. In this way, foreground and background of the overall light distribution stand out clearly from one another.

The first projection module and the second projection module can be implemented using technologies known per se. In one preferred configuration, the first projection module and/or the second projection module each comprise one or more laser diodes and/or LEDs as light source or light sources. A compact structure of the respective projection modules is ensured in this way.

In a further preferred embodiment, the first projection module and/or the second projection module is a DMD projection module in each case. DMD projection modules are known per se from the prior art and contain a so-called DMD device (DMD=digital mirror device). This is a micromirror array made up of a multiplicity of tiltable individual mirrors, which reflect the light of one or more light sources. Different projections can be effectuated by suitable activation of the micromirrors. Alternatively, other technologies can also be used for the first or the second projection module. In particular, the first or the second projection module may be a multichannel projection unit having an array of projection lenses. Such a projection unit is described in the above-mentioned document DE 10 2013 211 877 A1.

In a further preferred variant of the motor vehicle according to the invention, the plurality of projection modules comprises, in addition to the first and the second projection module, one or more further projection modules which are designed and arranged in such a way that during operation they each generate a light distribution which overlaps with the first light distribution and covers a smaller area on the ground than the first light distribution and also has a higher average illuminance on the ground than the first light distribution. In this way, the foreground in the overall light distribution created can be generated by multiple light distributions.

In one particularly preferred embodiment, the illuminance of the light distribution of at least one of the further projection modules and preferably of each further projection module is selected in such a way that it is 200% or more of the average illuminance of the first light distribution on the ground. Furthermore, the area of the light distribution of at least one of the further projection modules and preferably of each further projection module is preferably selected in such a way that it occupies 50% or less of the area of the first light distribution on the ground.

In one preferred embodiment, the light distribution of at least one of the further projection modules and preferably of each further projection module contains symbols, for example in the form of one or more graphic and/or text elements. In a further preferred variant, the light distribution of at least one of the further projection modules and preferably of each further projection module is located completely inside the first light distribution.

In a further preferred embodiment, at least one of the further projection modules and preferably each further projection module is designed in such a way that it creates white light or colored light and/or that it comprises one or more laser diodes and/or LEDs as light source or light sources and/or that it is a DMD projection module or a multichannel projection unit having an array of projection lenses.

In a further variant, the first projection module is designed in such a way that the first light distribution can be varied. Alternatively or additionally, the second projection module is designed in such a way that the second light distribution can be varied. Alternatively or additionally, at least one of the further projection modules and preferably each further projection module is designed in such a way that the light distribution generated thereby can be varied. In particular, the shape and/or the size and/or the displayed content and/or the position and/or the color and/or the contrast of the corresponding light distribution can be varied here.

In a further embodiment of the motor vehicle according to the invention, the first projection module and the second projection module are designed and arranged in such a way that, when they are in operation, the first light distribution and the second light distribution are generated on the ground in front of the front of the motor vehicle. In one preferred variant of this embodiment, the first projection module is installed in one headlight of the motor vehicle and the second projection module is installed in another headlight of the motor vehicle. The installation space for the motor vehicle headlights can thus also be used for the projection modules, without it being necessary to provide a separate installation location. If appropriate, at least one of the further projection modules and in particular each further projection module may be designed and arranged in such a way that, during operation, it generates a light distribution on the ground in front of the front of the motor vehicle.

In a modified embodiment, the light distributions of the first and the second projection module and if appropriate also of at least one of the further projection modules and in particular of each further projection module are created at a location other than in front of the front of the motor vehicle. In particular, the light distributions may also be generated on the ground laterally adjacent to the motor vehicle or behind the rear of the motor vehicle.

Exemplary embodiments of the invention are described in detail hereinafter with reference to the appended figures.

### BRIEF DESCRIPTION OF THE DRAWINGS

FIG. 1 shows a top view from above of an embodiment of a motor vehicle according to the invention.

FIG. 2 shows a top view from above of a further embodiment of a motor vehicle according to the invention.

### DETAILED DESCRIPTION OF THE DRAWINGS

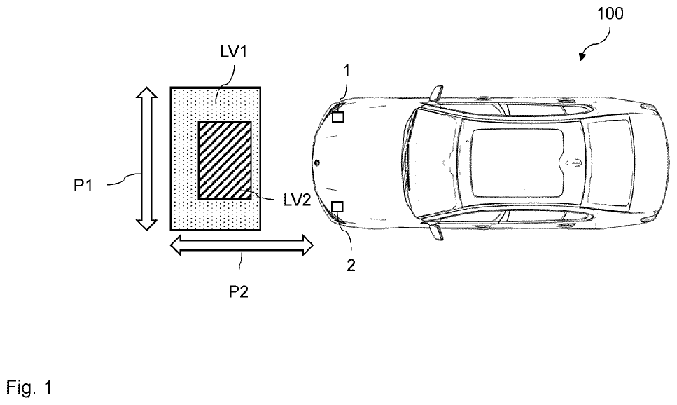

Variants of the invention are described hereinafter with reference to a surroundings lighting device, which is installed in the front of a motor vehicle. FIG. 1 shows a first embodiment of a corresponding motor vehicle 100, which is illustrated in a top view. The motor vehicle is a passenger car and contains a surroundings lighting device in the form of two projection modules 1 and 2, which are indicated merely schematically by rectangles. The projection module 1 is installed in the right-hand headlight of the motor vehicle and the projection module 2 is installed in the left-hand headlight of the motor vehicle. The two projection modules are based on technologies known per se. They are preferably DMD projectors, which project the light of a light source onto the ground in the surroundings of the motor vehicle by way of an array made up of movable micromirrors. Variable light distributions can be generated using such projectors. In particular, the shape and/or the size and/or the displayed content and/or the position and/or the color and/or the contrast of the corresponding light distribution can be suitably adapted via a digital controller.

According to the embodiment of FIG. 1, an overall light distribution, which is composed of a light distribution LV1 for the background and a light distribution LV2 for the foreground, is generated on the ground in front of the motor vehicle 100 using the two projection modules 1 and 2. The light distributions LV1 and LV2 are illustrated merely schematically, wherein the area of the light distribution LV1 is indicated by a dotted rectangle and the area of the light distribution LV2 is indicated by a diagonally shaded rectangle. The light distribution LV1 is created by the projection module 1 and the light distribution LV2 is created by the projection module 2. It is essential to an embodiment of the invention here that the two light distributions overlap with one another, wherein, in the embodiment of FIG. 1, the light distribution LV2 is located completely inside the light distribution LV1. Since the light distribution LV1 constitutes the background of the overall light distribution, its illuminance on the ground is less than that of the light distribution LV2, which constitutes the foreground of the overall light distribution and accordingly has to stand out from the light distribution LV1.

In one preferred embodiment, the light distribution LV1 is a homogeneously illuminated area, whereas symbols having a significance for a human observer are displayed using the light distribution LV2. In one variant, these symbols are a logo, for example the logo of the producer of the motor vehicle 100.

Pleasant light distributions made up of a foreground and a background can be generated very flexibly via the use of two separate projection modules 1 and 2. The generation of the light distributions may here be coupled to specific events, for example the unlocking of the doors of the motor vehicle using a radio key. Pleasant welcome scenarios for a driver can be created in this way.

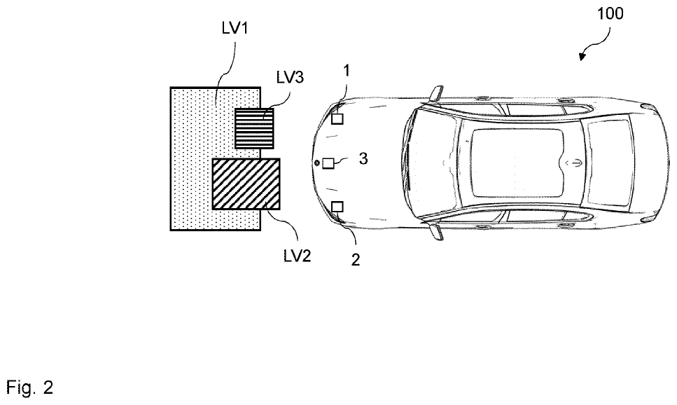

In FIG. 1, the double arrows P1 and P2, which are not part of the generated light distributions, indicate the preferred region in which the light distributions LV1 and LV2 are positioned in front of the motor vehicle. The double arrow P1 extends in the transverse direction of the motor vehicle. It is two meters long and its center is located on the longitudinal axis of the motor vehicle, which runs centrally through the motor vehicle. The double arrow P2 extends in the longitudinal direction of the motor vehicle and covers a distance of five meters in front of the motor vehicle. In one preferred variant of the invention, the generated light distributions LV1 and LV2 are located inside the regions spanned by the arrows P1 and P2, i.e. up to a distance in the longitudinal direction of five meters from the front of the motor vehicle and up to a distance of one meter in each case in the transverse direction from the longitudinal axis of the motor vehicle. The light distributions LV1, LV2 and LV3 shown in FIG. 2 are preferably also located inside this region. To ensure good perceptibility for persons inside and outside the motor vehicle, in a further preferred variant the individual light distributions LV1 and LV2 of FIG. 1 and also the light distributions LV1, LV2 and LV3 of FIG. 2 each have an area of at least 0.5 m². Preferably, each light distribution has an area of between 2 m² and 8 m².

In one preferred embodiment, the content of the light distribution LV1 and/or of the light distribution LV2 may be freely selected over their/its full area. For example, the projection may be sharply focused at each point on the ground. There is also the option that fuzzy contours can be indicated and the content of the projection can be recognized only schematically. Such projections are used in particular for the light distribution LV1 used as the background, whereas the light distribution LV2 is preferably displayed sharply, in order in this respect to display symbols clearly recognizably, for example.

FIG. 2 shows a second embodiment of a motor vehicle 100 according to the invention. Similarly to the motor vehicle of FIG. 1, the motor vehicle of FIG. 2 also contains the two projection modules 1 and 2, wherein the projection module 1 is installed in the right-hand headlight and the projection module 2 is installed in the left-hand headlight. The projection module 1 creates a light distribution LV1 in the form of a homogeneously illuminated area, which is used as background and is indicated merely schematically by a dotted rectangle. The light distribution LV2, which is schematically indicated by a diagonally shaded area, is generated using the projection module 2 and contains symbols. The light distribution LV2 constitutes the foreground of the overall light distribution. Similarly to the light distribution LV2 of FIG. 1, the light distribution LV2 of FIG. 2 has a higher illuminance than the light distribution LV1 and covers a smaller area on the ground in front of the motor vehicle than the light distribution LV1 does. In contrast to FIG. 1, the light distribution LV2 of FIG. 2 is not located completely inside the light distribution LV1, but rather only part of the light distribution LV2 coincides with the light distribution LV1.

The motor vehicle 100 of FIG. 2 additionally contains a further projection module 3, which is arranged centrally in the region of the grill of the motor vehicle. Using this projection module 3 a third light distribution LV3 is generated, which similarly to the light distribution LV2 has a higher illuminance than the light distribution LV1 and is thus also used to create a foreground in the overall light distribution. The light distribution LV3 is indicated only schematically by a horizontally shaded region. Similarly to the light distribution LV2, the light distribution LV3 contains symbols and partially coincides with the light distribution LV1. The projection modules 1 and 2 and also the further projection module 3 are preferably in turn implemented as DMD projectors and can thus generate variable light distributions.

Two embodiments were described above, in which an overall light distribution is generated in front of the front of the motor vehicle by way of a surroundings lighting device made up of two or three separate projection modules. This overall light distribution is composed of the light distributions of the separate projection modules. In modified embodiments, it is also possible to use more than three projection modules for creating the light distribution. It is essential to the embodiment of invention here that at least one light distribution having lower illuminance is generated on the ground, which light distribution forms a background of the overall light distribution, and furthermore at least one light distribution having higher illuminance is created, which light distribution forms the foreground of the overall light distribution and overlaps with the light distribution of the background. In a further modified embodiment, the light distributions of the individual projection modules may also be created at positions in the surroundings of the motor vehicle other than in front of its front, for example laterally adjacent to the motor vehicle or else behind the rear of the motor vehicle.

The above described embodiments of the invention have a series of advantages. In particular, for the first time what is provided is a motor vehicle with a surroundings lighting device, which using multiple projection modules creates an overall light distribution which is composed of a light distribution for the background and a light distribution for the foreground. In this way, pleasant light scenarios can be implemented and the overall light distribution can be adapted flexibly by the use of multiple light projections.

### LIST OF REFERENCE SIGNS

100 motor vehicle
1, 2, 3 projection modules
LV1, LV2, LV3 light distributions
P1, P2 double arrows

1.-11. (canceled)

12. A motor vehicle comprising:
a surroundings lighting device comprising a plurality of projection modules for creating light distributions on a ground in surroundings of the motor vehicle, wherein:
the plurality of projection modules comprises a first projection module and a second projection module, which are configured and arranged such that, when the first projection module and the second projection module are in operation, the first projection module generates a first light distribution on the ground in the surroundings of the motor vehicle and the second projection module generates a second light distribution, overlapping with the first light distribution, on the ground in the surroundings of the motor vehicle,
the second light distribution covers a smaller area on the ground than the first light distribution, and
the second light distribution has a higher average illuminance on the ground than the first light distribution.

13. The motor vehicle according to claim 12, wherein at least one of:
an average illuminance of the second light distribution on the ground is 200% or more of an average illuminance of the first light distribution on the ground, or
an area of the second light distribution on the ground is 50% or less of an area of the first light distribution on the ground.

14. The motor vehicle according to claim 12, wherein the second light distribution contains symbols.

15. The motor vehicle according to claim 12, wherein the second light distribution is located completely inside the first light distribution.

16. The motor vehicle according to claim 12, wherein the first light distribution is a homogeneously illuminated area or a predefined pattern.

17. The motor vehicle according to claim 12, wherein at least one of the first projection module or the second projection module is configured for generating white light or colored light.

18. The motor vehicle according to claim 12, wherein at least one of the first projection module or the second projection module comprises at least one of one or more laser diodes or LEDs as a light source or light sources.

19. The motor vehicle according to claim 12, wherein at least one of the first projection module or the second projection module is a DMD projection module or a multichannel projection unit having an array of projection lenses.

20. The motor vehicle according to claim 12, wherein the plurality of projection modules comprises one or more further projection modules, which are configured and arranged such that, during operation, each of the further projection modules generates a third light distribution, which overlaps with the first light distribution, covers a smaller area on the ground than the first light distribution, and has a higher average illuminance on the ground than the first light distribution.

21. The motor vehicle according to claim 12, wherein at least one of:
the first projection module is configured such that the first light distribution is variable, or
the second projection module is configured such that the second light distribution is variable.

22. The motor vehicle according to claim 12, wherein
the first projection module and the second projection module are configured and arranged such that, when the first projection module and the second projection module are in operation, the first light distribution and the second light distribution are generated on the ground in front of the front of the motor vehicle.

23. The motor vehicle according to claim 22,
wherein the first projection module is installed in one headlight of the motor vehicle and the second projection module is installed in another headlight of the motor vehicle.
